(19) United States
(12) Patent Application Publication
(10) Pub. No.: US 2022/0108277 A1
(43) Pub. Date: Apr. 7, 2022

(54) METHOD AND SYSTEM FOR PROVIDING AN INTEGRATED ORGANIZATIONAL USER INTERFACE

(71) Applicant: JPMorgan Chase Bank, N.A., New York, NY (US)

(72) Inventors: Israel CHORZEVSKI, Bnei Brak (IL); Shafir BALITSKY, Givaataim (IL); Yarden RON, Modi-in (IL)

(73) Assignee: JPMorgan Chase Bank, N.A., New York, NY (US)

(21) Appl. No.: 17/447,853

(22) Filed: Sep. 16, 2021

Related U.S. Application Data
(60) Provisional application No. 63/086,263, filed on Oct. 1, 2020.

(51) Int. Cl. G06Q 10/10

(52) U.S. Cl. CPC G06Q 10/107; G06Q 10/1097; G06Q 10/1095

(57) ABSTRACT

A method for providing organizational information in an integrated graphical user interface is disclosed. The method includes receiving, from a personal information manager, a request relating to the organizational information; compiling data from the personal information manager, the data including event information for an event and corresponding participant information for a participant; parsing the data to identify contact information for the participant; identifying, by using the contact information, supplemental information for the participant from a directory; generating an organizational user interface based on the contact information and the supplemental information; and transmitting, to the personal information manager, the organizational user interface in response to the at least one request.

### CROSS-REFERENCE TO RELATED APPLICATIONS

This application claims the benefit of U.S. Provisional Patent Application Ser. No. 63/086,263, filed Oct. 1, 2020, which is hereby incorporated by reference in its entirety.

### BACKGROUND

### 1. Field of the Disclosure

This technology generally relates to methods and systems for providing organizational information, and more particularly to methods and systems for providing organizational information in an automatically generated graphical user interface of a productivity tool that is integrated into a personal information manager.

### 2. Background Information

Many business entities utilize multi-user personal information managers such as, for example, MICROSOFT OUTLOOK to provide collaboration functionalities for employees. The personal information managers offer functionalities such as, for example, a mailbox, a calendar, and a meeting scheduler to assist the employees with day-to-day business operations that require coordination between different groups of employees. Historically, the provided functionalities have resulted in varying degrees of success with respect to facilitating collaboration between groups of employees who may not have working relationships.

One drawback of using conventional functionalities such as, for example, the meeting scheduling functionality provided by personal information managers is that in many instances, a participant of a meeting may not know the other participants in the meeting. As a result, valuable meeting time must be dedicated to participant introductions instead of the meeting's subject matter. In addition, the burden of managing participant information falls largely on each of the individual participants resulting in duplicate time and effort spent on researching the participant information.

Therefore, there is a need for a productivity tool that is integrable into personal information managers to enhance collaboration between participants by automatically and intelligently providing organizational information to each of the participants.

### SUMMARY

The present disclosure, through one or more of its various aspects, embodiments, and/or specific features or sub-components, provides, inter alia, various systems, servers, devices, methods, media, programs, and platforms for providing organizational information in an automatically generated graphical user interface of a productivity tool that is integrated into a personal information manager.

According to an aspect of the present disclosure, a method for providing organizational information in an integrated graphical user interface is provided. The method may be implemented by at least one processor. The method may include receiving, from a personal information manager, at least one request relating to the organizational information; compiling data from the personal information manager, the data including event information for at least one event and corresponding participant information for at least one participant; parsing the data to identify contact information for the at least one participant; identifying, by using the contact information, supplemental information for the at least one participant from at least one directory; generating an organizational user interface based on the contact information and the supplemental information; and transmitting, to the personal information manager, the organizational user interface in response to the at least one request.

In accordance with an exemplary embodiment, the organizational user interface may include at least one from among a web application displayable via a browser interface and a plug-in application of the personal information manager.

In accordance with an exemplary embodiment, the method may further include receiving, from a user via the organizational user interface, at least one private note corresponding to the at least one participant; associating the at least one private note with the user; appending the association as metadata into the at least one private note; and storing, in a private notes database, the at least one private note.

In accordance with an exemplary embodiment, the stored at least one private note may only be viewable by the user.

In accordance with an exemplary embodiment, the method may further include receiving, from a user via the organizational user interface, at least one public tag corresponding to the at least one participant; associating the at least one public tag with the at least one participant; and updating, for the at least one participant, the at least one directory with the association and the at least one public tag.

In accordance with an exemplary embodiment, the supplemental information corresponding to the at least one participant may include the at least one public tag.

In accordance with an exemplary embodiment, the method may further include compiling participant data corresponding to the at least one participant, the participant data may be compiled from an internal data source and a third-party data source; automatically generating, by using at least one model, at least one participant tag for the at least one participant; associating the at least one participant tag with the at least one participant; and updating, for the at least one participant, the at least one directory with the association and the at least one participant tag.

In accordance with an exemplary embodiment, the at least one model may include at least one from among a machine learning model, a mathematical model, a process model, and a data model.

In accordance with an exemplary embodiment, the personal information manager may include at least one from among an email client, a calendar client, a task management client, a contact client, a note-taking client, and a web browsing client.

In accordance with an exemplary embodiment, the at least one event may be managed by the personal information manager, the at least one event may include at least one from among a meeting item and a group email item.

According to an aspect of the present disclosure, a computing device configured to implement an execution of a method for providing organizational information in an integrated graphical user interface is disclosed. The computing device comprising a processor; a memory; and a communication interface coupled to each of the processor and the memory, wherein the processor may be configured to receive, from a personal information manager, at least one request relating to the organizational information; compile data that is obtainable from the personal information manager, the data may include event information for at least one event and corresponding participant information for at least one participant; parse the data to identify contact information for the at least one participant; identify, by using the contact information, supplemental information for the at least one participant from at least one directory; generate an organizational user interface based on the contact information and the supplemental information; and transmit, to the personal information manager, the organizational user interface in response to the at least one request.

In accordance with an exemplary embodiment, the organizational user interface may include at least one from among a web application that is displayable via a browser interface and a plug-in application of the personal information manager.

In accordance with an exemplary embodiment, the processor may be further configured to receive, from a user via the organizational user interface, at least one private note corresponding to the at least one participant; associate the at least one private note with the user; append the association as metadata into the at least one private note; and store, in a memory, the at least one private note.

In accordance with an exemplary embodiment, the processor may be further configured to cause the stored at least one private note to be viewable only by the user.

In accordance with an exemplary embodiment, the processor may be further configured to receive, from a user via the organizational user interface, at least one public tag corresponding to the at least one participant; associate the at least one public tag with the at least one participant; and update, for the at least one participant, the at least one directory with the association and the at least one public tag.

In accordance with an exemplary embodiment, the supplemental information corresponding to the at least one participant may include the at least one public tag.

In accordance with an exemplary embodiment, the processor may be further configured to compile participant data corresponding to the at least one participant, the participant data may be obtainable from at least one from among an internal data source and a third-party data source; automatically generate, by using at least one model, at least one participant tag based on the compiled participant data; associate the at least one participant tag with the at least one participant; and update, for the at least one participant, the at least one directory with the association and the at least one participant tag.

In accordance with an exemplary embodiment, the at least one model may include at least one from among a machine learning model, a mathematical model, a process model, and a data model.

In accordance with an exemplary embodiment, the personal information manager may include at least one from among an email client, a calendar client, a task management client, a contact client, a note-taking client, and a web browsing client.

In accordance with an exemplary embodiment, the processor may be further configured to manage the at least one event by using the personal information manager, the at least one event may include at least one from among a meeting item and a group email item.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates an exemplary computer system.

FIG. 2 illustrates an exemplary diagram of a network environment.

FIG. 3 shows an exemplary system for implementing a method for providing organizational information in an automatically generated graphical user interface of a productivity tool that is integrated into a personal information manager.

FIG. 4 is a flowchart of an exemplary process for implementing a method for providing organizational information in an automatically generated graphical user interface of a productivity tool that is integrated into a personal information manager.

FIG. 5 is an architecture diagram of an exemplary process for implementing a method for providing organizational information in an automatically generated graphical user interface of a productivity tool that is integrated into a personal information manager.

FIG. 6 is a screenshot that illustrates a graphical user interface that is usable for implementing a method for providing organizational information in an automatically generated graphical user interface of a productivity tool that is integrated into a personal information manager, according to an exemplary embodiment.

FIG. 7 is an expanded screenshot that illustrates a graphical user interface that is usable for implementing a method for providing organizational information in an automatically generated graphical user interface of a productivity tool that is integrated into a personal information manager, according to an exemplary embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

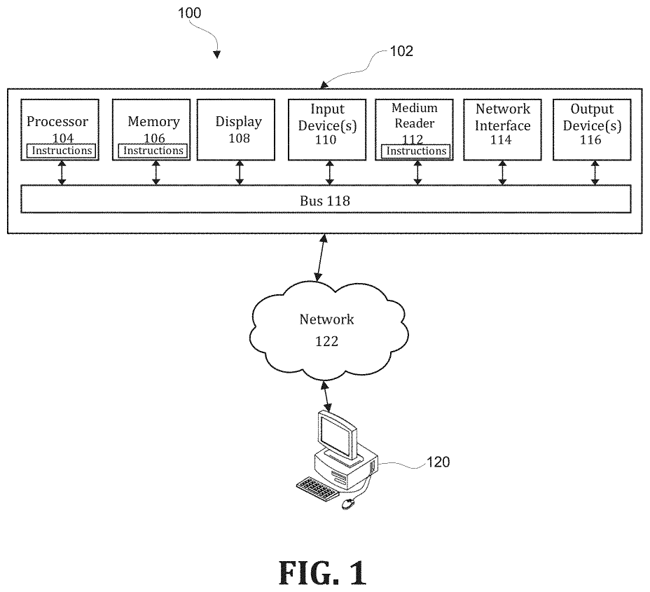

FIG. 1 is an exemplary system for use in accordance with the embodiments described herein. The system 100 is generally shown and may include a computer system 102, which is generally indicated.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, blu-ray disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid-state display, a cathode ray tube (CRT), a plasma display, or any other type of display, examples of which are well known to skilled persons.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software, or any combination thereof which are commonly known and understood as being included with or within a computer system, such as, but not limited to, a network interface 114 and an output device 116. The output device 116 may be, but is not limited to, a speaker, an audio out, a video out, a remote-control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionalities as described herein, and a processor described herein may be used to support a virtual processing environment.

As described herein, various embodiments provide optimized methods and systems for providing organizational information in an automatically generated graphical user interface of a productivity tool that is integrated into a personal information manager.

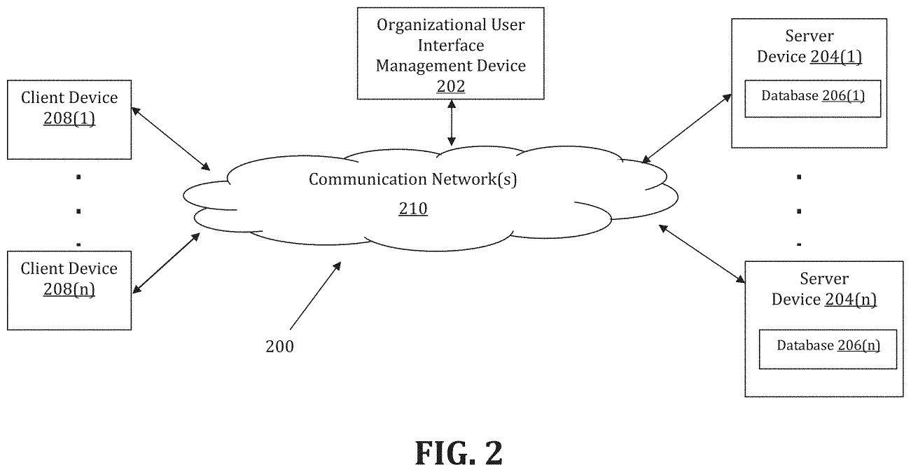

Referring to FIG. 2, a schematic of an exemplary network environment 200 for implementing a method for providing organizational information in an automatically generated graphical user interface of a productivity tool that is integrated into a personal information manager is illustrated. In an exemplary embodiment, the method is executable on any networked computer platform, such as, for example, a personal computer (PC).

The method for providing organizational information in an automatically generated graphical user interface of a productivity tool that is integrated into a personal information manager may be implemented by an Organizational User Interface Management (OUIM) device 202. The OUIM device 202 may be the same or similar to the computer system 102 as described with respect to FIG. 1. The OUIM device 202 may store one or more applications that can include executable instructions that, when executed by the OUIM device 202, cause the OUIM device 202 to perform actions, such as to transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the OUIM device 202 itself, may be located in virtual server(s) running in a cloud-based computing environment rather than being tied to one or more specific physical network computing devices. Also, the application(s) may be running in one or more virtual machines (VMs) executing on the OUIM device 202. Additionally, in one or more embodiments of this technology, virtual machine(s) running on the OUIM device 202 may be managed or supervised by a hypervisor.

In the network environment 200 of FIG. 2, the OUIM device 202 is coupled to a plurality of server devices 204(1)-204(n) that hosts a plurality of databases 206(1)-206(n), and also to a plurality of client devices 208(1)-208(n) via communication network(s) 210. A communication interface of the OUIM device 202, such as the network interface 114 of the computer system 102 of FIG. 1, operatively couples and communicates between the OUIM device 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the OUIM device 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides a number of advantages including methods, non-transitory computer readable media, and OUIM devices that efficiently implement a method for providing organizational information in an automatically generated graphical user interface of a productivity tool that is integrated into a personal information manager.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The OUIM device 202 may be a standalone device or integrated with one or more other devices or apparatuses, such as one or more of the server devices 204(1)-204(n), for example. In one particular example, the OUIM device 202 may include or be hosted by one of the server devices 204(1)-204(n), and other arrangements are also possible. Moreover, one or more of the devices of the OUIM device 202 may be in a same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the OUIM device 202 via the communication network(s) 210 according to the HTTP-based and/or JavaScript Object Notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store data that relates to contact data, phonebook data, private notes, public tags, participant tags, and generated models.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that can interact with the OUIM device 202 via communication network(s) 210. Accordingly, the client devices 208(1)-208(n) may be mobile computing devices, desktop computing devices, laptop computing devices, tablet computing devices, virtual machines (including cloud-based computers), or the like, that host chat, e-mail, or voice-to-text applications, for example. In an exemplary embodiment, at least one client device 208 is a wireless mobile communication device, i.e., a smart phone.

The client devices 208(1)-208(n) may run interface applications, such as standard web browsers or standalone client applications, which may provide an interface to communicate with the OUIM device 202 via the communication network(s) 210 in order to communicate user requests and information. The client devices 208(1)-208(n) may further include, among other features, a display device, such as a display screen or touchscreen, and/or an input device, such as a keyboard, for example.

Although the exemplary network environment 200 with the OUIM device 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the OUIM device 202, the server devices 204(1)-204(n), or the client devices 208(1)-208(n), for example, may be configured to operate as virtual instances on the same physical machine. In other words, one or more of the OUIM device 202, the server devices 204(1)-204(n), or the client devices 208(1)-208(n) may operate on the same physical device rather than as separate devices communicating through communication network(s) 210. Additionally, there may be more or fewer OUIM devices 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication, also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

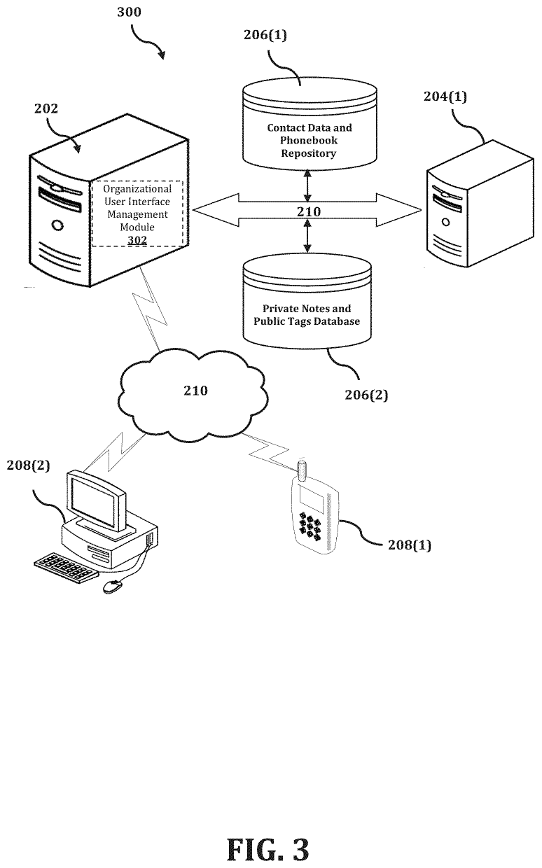

The OUIM device 202 is described and shown in FIG. 3 as including an organizational user interface management module 302, although it may include other rules, policies, modules, databases, or applications, for example. As will be described below, the organizational user interface management module 302 is configured to implement a method for providing organizational information in an automatically generated graphical user interface of a productivity tool that is integrated into a personal information manager.

An exemplary process 300 for implementing a mechanism for providing organizational information in an automatically generated graphical user interface of a productivity tool that is integrated into a personal information manager by utilizing the network environment of FIG. 2 is shown as being executed in FIG. 3. Specifically, a first client device 208(1) and a second client device 208(2) are illustrated as being in communication with OUIM device 202. In this regard, the first client device 208(1) and the second client device 208(2) may be “clients” of the OUIM device 202 and are described herein as such. Nevertheless, it is to be known and understood that the first client device 208(1) and/or the second client device 208(2) need not necessarily be “clients” of the OUIM device 202, or any entity described in association therewith herein. Any additional or alternative relationship may exist between either or both of the first client device 208(1) and the second client device 208(2) and the OUIM device 202, or no relationship may exist.

Further, OUIM device 202 is illustrated as being able to access a contact data and phonebook repository 206(1) and a private notes and public tags database 206(2). The organizational user interface management module 302 may be configured to access these databases for implementing a method for providing organizational information in an automatically generated graphical user interface of a productivity tool that is integrated into a personal information manager.

The first client device 208(1) may be, for example, a smart phone. Of course, the first client device 208(1) may be any additional device described herein. The second client device 208(2) may be, for example, a personal computer (PC). Of course, the second client device 208(2) may also be any additional device described herein.

The process may be executed via the communication network(s) 210, which may comprise plural networks as described above. For example, in an exemplary embodiment, either or both of the first client device 208(1) and the second client device 208(2) may communicate with the OUIM device 202 via broadband or cellular communication. Of course, these embodiments are merely exemplary and are not limiting or exhaustive.

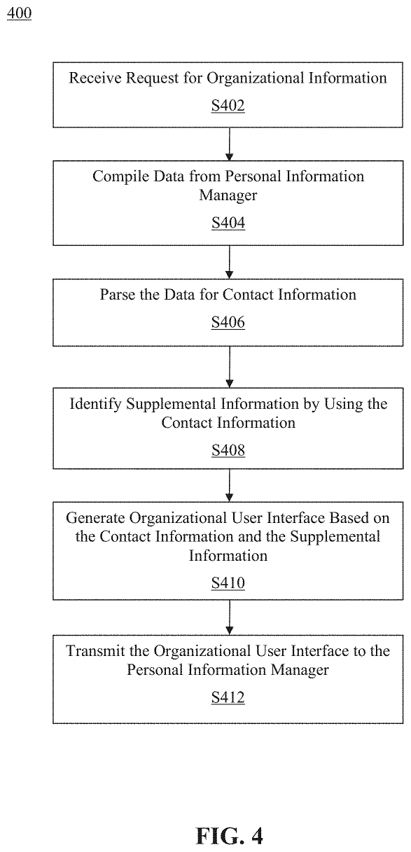

Upon being started, the organizational user interface management module 302 executes a process for providing organizational information in an automatically generated graphical user interface of a productivity tool that is integrated into a personal information manager. An exemplary process for providing organizational information in an automatically generated graphical user interface of a productivity tool that is integrated into a personal information manager is generally indicated at flowchart 400 in FIG. 4.

In the process 400 of FIG. 4, at step S402, a request for organizational information may be received from a personal information manager. The request may be initiated by a user of the personal information manager. In an exemplary embodiment, the request may include an action by the user on the graphical user interface of the personal information manager. For example, the user may request real-time organizational information for a meeting by selecting a graphical element on a meeting invite. In another exemplary embodiment, the request may be initiated automatically by the personal information manager. For example, the personal information manager may automatically request organizational information for a meeting when a user creates and sends a meeting invite to a plurality of participants. A person of ordinary skill in the art would appreciate that improvements in response times for a user may be realized by automatically requesting organizational information in advance of user need.

In another exemplary embodiment, the personal information manager may include at least one from among an email client, a calendar client, a task management client, a contact client, a note-taking client, and a web browsing client. The personal information manager may include an application software that functions as a personal organizer of various information for a user. For example, the user information may include address books, alerts, calendar appointments, calendar events, calendar meetings, email addresses, passwords, and login credentials. In another exemplary embodiment, the personal information manager may include stand-alone applications used by an individual as well as multi-user software utilized by organizations. The applications may be primarily web based such as, for example, GOOGLE CALENDAR as well as operating system based such as, for example, MICROSOFT OUTLOOK.

At step S404, data from the personal information manager may be compiled. The data may include event information for an event and corresponding participant information for a participant. In an exemplary embodiment, the event may be managed by the personal information manager and may include at least one from among a meeting item and a group email item. For example, the event may include a meeting and/or a group email initiated via the personal information manager. Similarly, the participants may include users indicated as participating in the meeting and/or group email. As will be appreciated by a person of ordinary skill in the art, the participant information may include a name, an email address, and any corresponding details appended to the participant such as, for example, a job title, a carbon copy (CC) status, a blind carbon copy (BCC) status, a meeting accepted status, and a meeting declined status.

At step S406, the data may be parsed to identify contact information for the participant. The data may be received as a string of symbols in a natural language format, a computer language format, and a data structures format from the personal information manager. In an exemplary embodiment, syntactic analysis may be performed on the string of symbols based on rules of formal grammar such as, for example, a first name followed by a last name to identify contact information for the participant. The syntactic analysis may result in a parse tree showing syntactic relationships between various data elements. In another exemplary embodiment, the participant contact information may include participant identifiers and may correspond to participant information such as, for example, a name, an email address, and any relating details. As will be appreciated by a person of ordinary skill in the art, the data may be pre-processed by the personal information manager and presented in a compatible format, in which case, parsing of the data may not be required.

At step S408, supplemental information for the participant may be identified from a directory by using the contact information. In an exemplary embodiment, supplemental information may include organizational information and other participant information not available to the personal information manager. For example, supplemental information for the participant may include a picture of the participant, the work group the participant belongs to, the geolocation of the participant, the time zone of the participant, as well as the participant's supervisors and subordinates. In another exemplary embodiment, the supplemental information may be retrieved from a business entity's phonebook directory via a lightweight directory access protocol (LDAP). The LDAP may include application protocols for accessing and maintaining distributed directory information services over an internet protocol network.

At step S410, an organizational user interface may be generated based on the contact information and the supplemental information. In an exemplary embodiment, the organizational user interface may include a graphical user interface displaying the contact information and the supplemental information for the participant. For example, the organizational user interface may display an organizational chart corresponding to all the participants of a meeting. In another exemplary embodiment, the organizational user interface may include selectable graphical elements to display additional participant information. For example, pictures of all meeting participants may be displayed in the organizational user interface. A user may then select one of the pictures to open a new dialog box with additional information of the participant corresponding to the selected picture.

In another exemplary embodiment, the organizational user interface may include at least one from among a web application displayable via a browser interface and a plug-in application of the personal information manager. The web application may include an application software that runs on a web server and accessed by a user through a web browser with an active internet connection. The plug-in application may include a software component that adds a specific feature to an existing computer program, such as, for example, a personal information manager. In another exemplary embodiment, the plug-in application may be directly integrated into the existing computer program. For example, the plug-in application, from the perspective of the user, functions as a feature of the existing computer program and may be indistinguishable as a separate application.

At step S412, the organizational user interface may be transmitted to the personal information manager in response to the request. In an exemplary embodiment, the organizational user interface may include a format corresponding to the request. For example, when a user requests the organizational user interface by selecting a graphical plug-in element in a meeting invitation, the organizational user interface may be presented in a format compatible with the plug-in application. When a user requests the organizational user interface by selecting a graphical web element in a meeting invitation, the organizational user interface may be presented in a format compatible with the web application.

In another exemplary embodiment, the organizational user interface may include selectable graphical elements to initiate contact with the participant. For example, a user may select a participant profile picture to display a menu that includes various contact channels such as, for example, an email, a SKYPE call, and a ZOOM call for the corresponding participant. In another exemplary embodiment, the organizational user interface may be customized based on predetermined filter preferences such as, for example, only showing information for participants with an associated developer tag. The organizational user interface may be exported by a user as well as edited by the user to add additional colleagues. For example, a user may add meeting notes and export a printer friendly version of the organizational user interface for use in a meeting.

In another exemplary embodiment, a private note corresponding to the participant may be received from a user via the organizational user interface. For example, the user may elect to add a private note to remind the user of talking points corresponding to a meeting participant. The private note may be associated with the user and the association may be appended as metadata into the private note. Then, the private note may be stored in a private notes database and/or a private note service. In another exemplary embodiment, the stored private note may only be viewable by the user.

In another exemplary embodiment, a public tag corresponding to the participant may be received from a user via the organizational user interface. For example, the user may elect to tag a participant as an expert in a technology field. The public tag may be associated with the participant. Then, a directory of participant information may be updated with the association and the public tag for the participant. In another exemplary embodiment, the supplemental information corresponding to the participant may include the public tag and may be viewable by all users of the personal information manager.

In another exemplary embodiment, participant data corresponding to the participant may be compiled. The participant data may be compiled from an internal data source and a third-party data source. Once the participant data has been compiled, a participant tag for the participant may be automatically generated by using a model. The participant tag may then be associated with the participant and a directory of participant information may be updated with the association and the participant tag for the participant.

In another exemplary embodiment, the model may include at least one from among a machine learning model, a mathematical model, a process model, and a data model. The model may also include stochastic models such as, for example, a Markov model that is used to model randomly changing systems. In stochastic models, the future states of a system may be assumed to depend only on the current state of the system. Additionally, the model may use the participant data compiled from internal and third-party sources to anticipate informational needs for a plurality of users. For example, the model may anticipate the need by the plurality of users for information relating to a job title of a particular meeting participant based on previous requests for job title information of other meeting participants.

In another exemplary embodiment, machine learning and pattern recognition may include supervised learning algorithms such as, for example, k-medoids analysis, regression analysis, decision tree analysis, random forest analysis, k-nearest neighbors analysis, logistic regression analysis, etc. In another exemplary embodiment, machine learning analytical techniques may include unsupervised learning algorithms such as, for example, Apriori analysis, K-means clustering analysis, etc. In another exemplary embodiment, machine learning analytical techniques may include reinforcement learning algorithms such as, for example, Markov Decision Process, etc.

In another exemplary embodiment, the model may be based on a machine learning algorithm. The machine learning algorithm may include at least one from among a process and a set of rules to be followed by a computer in calculations and other problem-solving operations such as, for example, a linear regression algorithm, a logistic regression algorithm, a decision tree algorithm, or a Naive Bayes algorithm.

In another exemplary embodiment, the model may include training models such as, for example, a machine learning model which is generated to be further trained on additional data. Once the training model has been sufficiently trained, the training model may be deployed onto various connected systems to be utilized. In another exemplary embodiment, the training model may be sufficiently trained when model assessment methods such as, for example, a holdout method, a K-fold-cross-validation method, and a bootstrap method determine that the training model's least squares error rate, true positive rate, true negative rate, false positive rate, and false negative rates are within predetermined ranges. In another exemplary embodiment, the training model may be operable, i.e., actively utilized by an organization, while continuing to be trained using new data. In another exemplary embodiment, the models may be generated using at least one from among an artificial neural network technique, a decision tree technique, a support vector machines technique, a Bayesian network technique, and a genetic algorithms technique.

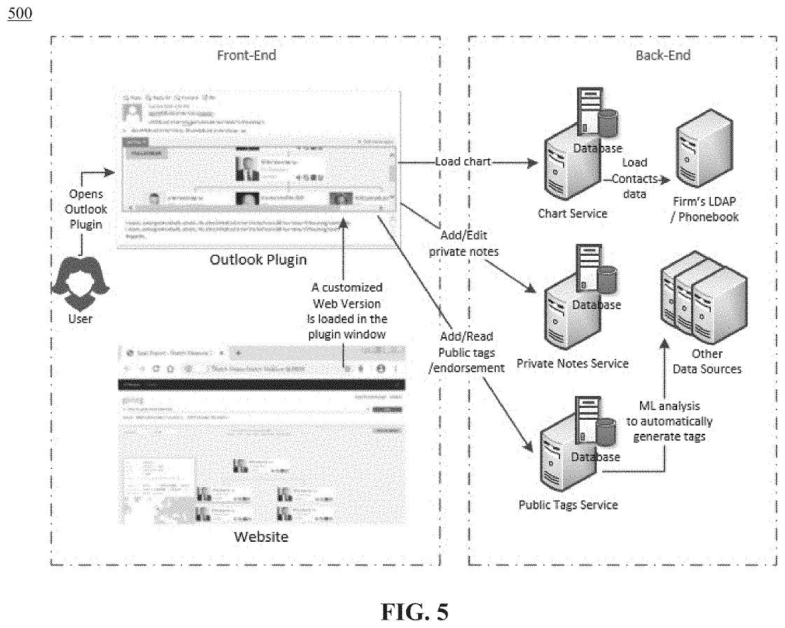

FIG. 5 is an architecture diagram 500 of an exemplary process for implementing a method for providing organizational information in an automatically generated graphical user interface of a productivity tool that is integrated into a personal information manager. The architectural diagram 500 includes front-end, client facing graphical elements and well as back-end processing elements. In an exemplary embodiment, the front-end side may be written in JavaScript and may be based on a library such as, for example, a REACT.JS library. In another exemplary embodiment, the back-end side may utilize representational state transfer (REST) protocols such as, for example, a hypertext transfer protocol (HTTP).

As illustrated in FIG. 5, the front end, client facing graphical elements may include a plug-in application on a personal information manager such as, for example, MICROSOFT OUTLOOK as well as a website in a browser. A user may interact with the plug-in application by initiating the personal information manager and selecting graphical elements corresponding to the plug-in application. In an exemplary embodiment, a customized web version of the organizational user interface may be loaded in the plug-in application window.

The back-end processing elements may include a process for loading an organizational chart via a chart service database. In turn, the chart service database, utilizing embodiments disclosed in the present application, loads contacts data from a business entity's phonebook directory via a lightweight directory access protocol (LDAP).

The back-end processing element may also include a process for managing user generated private notes. In this process, the user adds and/or edits a private note that is associated with a participant. The newly added and/or edited private note is transmitted to a private notes service database which manages a plurality of private notes according to embodiments disclosed in the present application.

The back-end processing element may similarly include a process for managing user generated public tags and endorsements. In this process, the user adds a public tag and/or an endorsement that is associated with a participant. The newly added public tag and/or endorsement is transmitted to a public tags service database which manages a plurality of public tags and/or endorsements according to embodiments disclosed in the present application. Additionally, the public tags service database may also utilize machine learning analysis to automatically generate public tags based on other data sources according to embodiments disclosed in the present application.

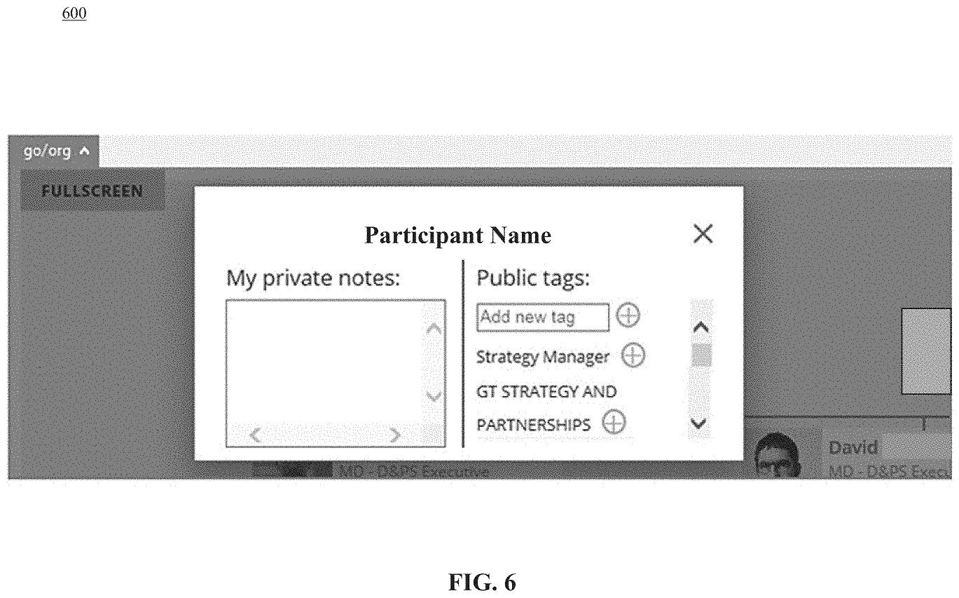

FIG. 6 is a screenshot 600 that illustrates a graphical user interface that is usable for implementing a method for providing organizational information in an automatically generated graphical user interface of a productivity tool that is integrated into a personal information manager, according to an exemplary embodiment. The screenshot 600 includes a feature window for a user to add private notes and/or public tags for a participant. In an exemplary embodiment, the feature window may be displayed when a user selects a graphical element such as, for example, a participant picture corresponding to a participant.

As illustrated in FIG. 6, the feature window includes the name of the participant upon which the private notes and/or the public tags may be associated. To add a private note for the participant, a text box is provided to receive inputs from the user. Similarly, to add a public tag, a text box is provided to receive inputs from the user. The public tags section may also include existing public tags that are already associated with the participant. The public tags section may include selectable graphical buttons such as, for example, a selectable plus button and a scroll bar to display additional public tag information. As will be appreciated by a person of ordinary skill in the art, the inputs received from the user may include alphabetic, numerical, and symbolic characters.

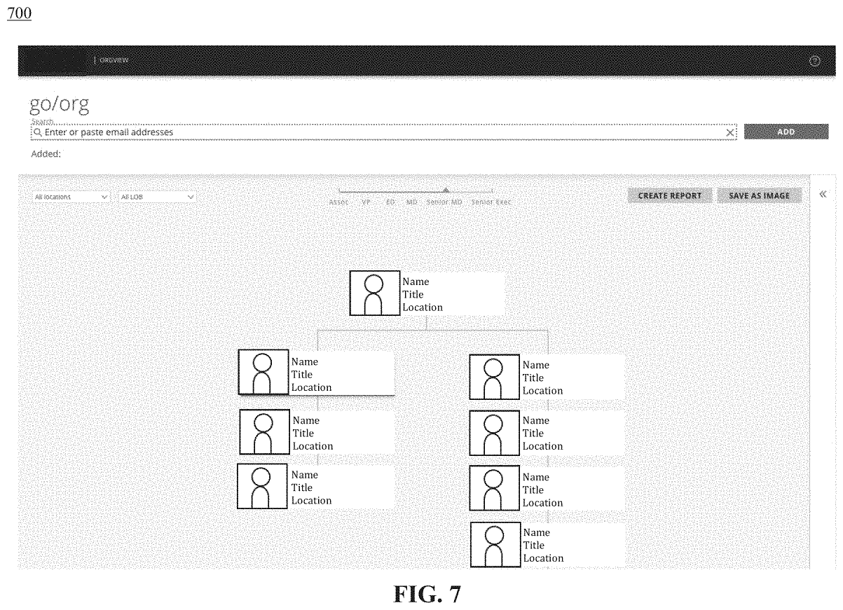

FIG. 7 is an expanded screenshot 700 that illustrates a graphical user interface that is usable for implementing a method for providing organizational information in an automatically generated graphical user interface of a productivity tool that is integrated into a personal information manager, according to an exemplary embodiment. The expanded screenshot 700 includes the features window as it would appear on the organizational user interface.

As illustrated in FIG. 7, the organizational user interface may be presented in an organizational chart format. In the organizational chart format, working groups of each participant may be displayed and lines between the working groups may be utilized to show working relationships. Additionally, a hierarchy of the working groups may also be displayed for context according to a predetermined preference such as, for example, a maximum level in the organizational chart to display. In an exemplary embodiment, information for the participants in an event may be highlighted to distinguish from other information on the organizational chart. For example, the information for participants in a meeting invitation may be highlighted to distinguish from other organizational information of individuals not in the meeting invitation.

Accordingly, with this technology, an optimized process for providing organizational information in an automatically generated graphical user interface of a productivity tool that is integrated into a personal information manager is disclosed.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for providing organizational information in an integrated graphical user interface, the method being implemented by at least one processor, the method comprising:
receiving, by the at least one processor from a personal information manager, at least one request relating to the organizational information;
compiling, by the at least one processor, data that is obtainable from the personal information manager, the data including event information for at least one event and corresponding participant information for at least one participant;
parsing, by the at least one processor, the data to identify contact information for the at least one participant;
identifying, by the at least one processor using the contact information, supplemental information for the at least one participant from at least one directory;
generating, by the at least one processor, an organizational user interface based on the contact information and the supplemental information; and
transmitting, by the at least one processor to the personal information manager, the organizational user interface in response to the at least one request.

2. The method of claim 1, wherein the organizational user interface includes at least one from among a web application that is displayable via a browser interface and a plug-in application of the personal information manager.

3. The method of claim 1, further comprising:
receiving, by the at least one processor from a user via the organizational user interface, at least one private note corresponding to the at least one participant;
associating, by the at least one processor, the at least one private note with the user;
appending, by the at least one processor, the association as metadata into the at least one private note; and
storing, by the at least one processor in a memory, the at least one private note.

4. The method of claim 3, wherein the stored at least one private note is only viewable by the user.

5. The method of claim 1, further comprising:
receiving, by the at least one processor from a user via the organizational user interface, at least one public tag corresponding to the at least one participant;
associating, by the at least one processor, the at least one public tag with the at least one participant; and
updating, by the at least one processor for the at least one participant, the at least one directory with the association and the at least one public tag.

6. The method of claim 5, wherein the supplemental information corresponding to the at least one participant includes the at least one public tag.

7. The method of claim 1, further comprising:
compiling, by the at least one processor, participant data corresponding to the at least one participant, the participant data being obtainable from at least one from among an internal data source and a third-party data source;
automatically generating, by the at least one processor using at least one model, at least one participant tag based on the compiled participant data;
associating, by the at least one processor, the at least one participant tag with the at least one participant; and
updating, by the at least one processor for the at least one participant, the at least one directory with the association and the at least one participant tag.

8. The method of claim 7, wherein the at least one model includes at least one from among a machine learning model, a mathematical model, a process model, and a data model.

9. The method of claim 1, wherein the personal information manager includes at least one from among an email client, a calendar client, a task management client, a contact client, a note-taking client, and a web browsing client.

10. The method of claim 1, wherein the at least one event is managed by the personal information manager, the at least one event including at least one from among a meeting item and a group email item.

11. A computing device configured to implement an execution of a method for providing organizational information in an integrated graphical user interface, the computing device comprising:
a processor;
a memory; and
a communication interface coupled to each of the processor and the memory,
wherein the processor is configured to:
receive, from a personal information manager, at least one request relating to the organizational information;
compile data that is obtainable from the personal information manager, the data including event information for at least one event and corresponding participant information for at least one participant;
parse the data to identify contact information for the at least one participant;
identify, by using the contact information, supplemental information for the at least one participant from at least one directory;
generate an organizational user interface based on the contact information and the supplemental information; and
transmit, to the personal information manager, the organizational user interface in response to the at least one request.

12. The computing device of claim 11, wherein the organizational user interface includes at least one from among a web application that is displayable via a browser interface and a plug-in application of the personal information manager.

13. The computing device of claim 11, wherein the processor is further configured to:
receive, from a user via the organizational user interface, at least one private note corresponding to the at least one participant;
associate the at least one private note with the user;
append the association as metadata into the at least one private note; and
store, in a memory, the at least one private note.

14. The computing device of claim 13, wherein the processor is further configured to cause the stored at least one private note to be viewable only by the user.

15. The computing device of claim 11, wherein the processor is further configured to:
receive, from a user via the organizational user interface, at least one public tag corresponding to the at least one participant;
associate the at least one public tag with the at least one participant; and
update, for the at least one participant, the at least one directory with the association and the at least one public tag.

16. The computing device of claim 15, wherein the supplemental information corresponding to the at least one participant includes the at least one public tag.

17. The computing device of claim 11, wherein the processor is further configured to:
compile participant data corresponding to the at least one participant, the participant data being obtainable from at least one from among an internal data source and a third-party data source;
automatically generate, by using at least one model, at least one participant tag based on the compiled participant data;
associate the at least one participant tag with the at least one participant; and
update, for the at least one participant, the at least one directory with the association and the at least one participant tag.

18. The computing device of claim 17, wherein the at least one model includes at least one from among a machine learning model, a mathematical model, a process model, and a data model.

19. The computing device of claim 11, wherein the personal information manager includes at least one from among an email client, a calendar client, a task management client, a contact client, a note-taking client, and a web browsing client.

20. The computing device of claim 11, wherein the processor is further configured to manage the at least one event by using the personal information manager, the at least one event including at least one from among a meeting item and a group email item.
